(19) United States
(12) Patent Application Publication
(10) Pub. No.: US 2010/0190145 A1
(43) Pub. Date: Jul. 29, 2010

(54) DEVICE, SYSTEM, AND METHOD OF KNOWLEDGE ACQUISITION

(75) Inventors: Avigail Singer, Kiryat Motskin (IL); Dov Weiss, Kiryat-Ono (IL)

Correspondence Address: EITAN MEHULAL LAW GROUP, 10 Abba Eban Blvd. PO Box 2081, Herzlia, 46120, IL

(73) Assignee: TIME TO KNOW LTD., St. Peter Port (GG)

(21) Appl. No.: 12/360,969

(22) Filed: Jan. 28, 2009

(51) Int. Cl. G09B 7/00; G09B 7/04

(52) U.S. Cl. 434/335; 434/322

(57) ABSTRACT

Device, system, and method of knowledge acquisition. For example, a system for computerized knowledge acquisition includes: a knowledge level testing module to present to a student a first set of questions in a modality at one or more difficulty levels, to receive from the student answers to said first set of questions, and to update a knowledge map of said student based on said answers; a guided knowledge acquisition module to present to the student a second set of questions in said modality, wherein the second set of questions corresponds to educational items for which it is determined that the student's performance in the first set of questions is below a threshold value; and a recycler module to present to the student an interactive game and a third set of questions in said modality, wherein the third set of questions corresponds to educational items for which it is determined that the student's performance in the first set of questions is equal to or greater than said pre-defined threshold.

### FIELD

Some embodiments are related to the field of computer-based teaching and computer-based learning.

### BACKGROUND

Many professionals and service providers utilize computers in their everyday work. For example, engineers, programmers, lawyers, accountants, bankers, architects, physicians, and various other professionals spend several hours a day utilizing a computer. In contrast, many teachers do not utilize computers for everyday teaching. In many schools, teachers use a “chalk and talk” teaching approach, in which the teacher conveys information to students by talking to them and by writing on a blackboard.

### SUMMARY

Some embodiments include, for example, devices, systems, and methods of knowledge acquisition.

In some embodiments, for example, a system for computerized knowledge acquisition includes: a knowledge level testing module to present to a student a first set of questions in a modality at one or more difficulty levels, to receive from the student answers to said first set of questions, and to update a knowledge map of said student based on said answers; a guided knowledge acquisition module to present to the student a second set of questions in said modality, wherein the second set of questions corresponds to educational items for which it is determined that the student's performance in the first set of questions is below a threshold value; and a recycler module to present to the student an interactive game and a third set of questions in said modality, wherein the third set of questions corresponds to educational items for which it is determined that the student's performance in the first set of questions is equal to or greater than said pre-defined threshold.

In some embodiments, for example, the modality includes a version of a digital learning activity adapted to accommodate a difficulty level appropriate to said student, and further adapted to accommodate at least one of: a learning preference associated with said student, and a weakness of said student.

In some embodiments, for example, the modality includes a version of the digital learning activity adapted by at least one of: addition of a feature of said digital learning activity; removal of a feature of said digital learning activity; modification of a feature of said digital learning activity; modification of a time limit associated with said digital learning activity; addition of audio narration; addition of a calculator tool; addition of a dictionary tool; addition of a on-mouse-over hovering bubble; addition of one or more hints; addition of a word-bank; and addition of subtitles.

In some embodiments, for example, the knowledge level test module is to perform, for each modality from a list of modalities associated with a learning subject, a first sub-test for a first difficulty level of said modality; and if the student's performance in said sub-test is equal to or greater than said threshold level, the knowledge level test module is to perform a second sub-test for a second, different, difficulty level of said modality.

In some embodiments, for example, the knowledge level test module is to modify status of at least one of the first set of questions into a value representing one of: pass, fail, skip, and untested.

In some embodiments, for example, the knowledge level test module is to dynamically generate said first set of questions based on: a discipline parameter (or a subject area parameter), a study unit parameter, a threshold parameter indicating a threshold value for advancement to an advanced difficulty level; and a batch size parameter indicating a maximum batch size for each level of difficulty.

In some embodiments, for example, the knowledge level test module is to dynamically generate the first set of questions further based on a parameter indicating whether to check the threshold value per set of questions or per modality.

In some embodiments, for example, the knowledge level test module is to dynamically generate the first set of questions further based on a level dependency parameter indicating whether or not to check the student's success in a previous difficulty level.

In some embodiments, for example, the knowledge level test module is to dynamically generate the first set of questions further based on data from a student profile indicating, for at least one discipline, at least one of: a pedagogic strength of the student, and a pedagogic weakness of the student.

In some embodiments, for example, the guided knowledge acquisition module is to check, for each difficulty level in a plurality of difficulty levels associated with said modality, whether or not the student's performance in said modality at said difficulty level is smaller than said threshold value; and if the check result is negative, to advance the student to a subsequent, increased, difficulty level for said modality.

In some embodiments, for example, the guided knowledge acquisition module is to advance the student from a first modality to a second modality according to an ordered list of modalities for said student in a pedagogic discipline.

In some embodiments, for example, the guided knowledge acquisition module is to present to the student a selectable option to receive a hint for at least one question of said second set of questions, based on a value of a parameter indicating whether or not to present hints to said student in said second set of questions.

In some embodiments, for example, the guided knowledge acquisition module is to present to the student a question in said second set of question, the question including two or more numerical values generated pseudo-randomly based on number of digits criteria.

In some embodiments, for example, the guided knowledge acquisition module is to present to the student two consecutive trials to correctly answer a question in said second set of questions, prior to presenting to the student a correct answer to said question.

In some embodiments, for example, the interactive game presented by the recycler module includes a game selected from the group consisting of: a memory game, a matching game, a spelling game, a puzzle game, and an assembly game.

In some embodiments, for example, the interactive game presented by the recycler module includes a combined list of vocabulary words, which is created by the recycler module based on: a first list of vocabulary words that the student mastered in a first time period ending at the creation of the combined list of vocabulary words, and a second list of vocabulary words that the student mastered in a second time period ending prior to the beginning of the first time period.

In some embodiments, for example, the recycler module is to create said combined list of vocabulary words based on: the first list of vocabulary words sorted based on respective recycling counters, and the second list of vocabulary words sorted based on respective recycling counters.

In some embodiments, for example, approximately half of vocabulary words in the combined list are included in the first list, and wherein approximately half of vocabulary words in the combined list are included in the second list.

In some embodiments, for example, a method of computerized knowledge acquisition includes: presenting to a student a first set of questions in a modality at one or more difficulty levels; receiving from the student answers to said first set of questions; updating a knowledge map of said student based on said answers; presenting to the student a second set of questions in said modality, wherein the second set of questions corresponds to educational items for which it is determined that the student's performance in the first set of questions is below a threshold value; presenting to the student an interactive game and a third set of questions in said modality, wherein the third set of questions corresponds to educational items for which it is determined that the student's performance in the first set of questions is equal to or greater than said pre-defined threshold.

In some embodiments, for example, the modality includes a version of a digital learning activity adapted to accommodate a difficulty level appropriate to said student, and further adapted to accommodate at least one of: a learning preference associated with said student, and a weakness of said student.

In some embodiments, for example, the modality includes a version of the digital learning activity adapted by at least one of: addition of a feature of said digital learning activity; removal of a feature of said digital learning activity; modification of a feature of said digital learning activity; modification of a time limit associated with said digital learning activity; addition of audio narration; addition of a calculator tool; addition of a dictionary tool; addition of a on-mouse-over hovering bubble; addition of one or more hints; addition of a word-bank; and addition of subtitles.

In some embodiments, for example, the method includes: performing, for each modality from a list of modalities associated with a learning subject, a first sub-test for a first difficulty level of said modality; and if the student's performance in said sub-test is equal to or greater than said threshold level, performing a second sub-test for a second, different, difficulty level of said modality.

In some embodiments, for example, the method includes: modifying status of at least one of the first set of questions into a value representing one of: pass, fail, slip, and untested.

In some embodiments, for example, the method includes: dynamically generating said first set of questions based on: a discipline parameter, a study unit parameter, a threshold parameter indicating a threshold value for advancement to an advanced difficulty level; and a batch size parameter indicating a maximum batch size for each level of difficulty.

In some embodiments, for example, the method includes: dynamically generating the first set of questions further based on a parameter indicating whether to check the threshold value per set of questions or per modality.

In some embodiments, for example, the method includes: dynamically generating the first set of questions further based on a level dependency parameter indicating whether or not to check the student's success in a previous difficulty level.

In some embodiments, for example, the method includes: dynamically generating the first set of questions further based on data from a student profile indicating, for at least one discipline, at least one of: a pedagogic strength of the student, and a pedagogic weakness of the student.

In some embodiments, for example, the method includes: for each difficulty level in a plurality of difficulty levels associated with said modality, checking whether or not the student's performance in said modality at said difficulty level is smaller than said threshold value; and if the checking result is negative, advancing the student to a subsequent, increased, difficulty level for said modality.

In some embodiments, for example, the method includes: advancing the student from a first modality to a second modality according to an ordered list of modalities for said student in a pedagogic discipline.

In some embodiments, for example, the method includes: presenting to the student a selectable option to receive a hint for at least one question of said second set of questions, based on a value of a parameter indicating whether or not to present hints to said student in said second set of questions.

In some embodiments, for example, the method includes: presenting to the student a question in said second set of question, the question including two or more numerical values generated pseudo-randomly based on number of digits criteria.

In some embodiments, for example, the method includes: presenting to the student two consecutive trials to correctly answer a question in said second set of questions, prior to presenting to the student a correct answer to said question.

In some embodiments, for example, the interactive game includes a game selected from the group consisting of: a memory game, a matching game, a spelling game, a puzzle game, and an assembly game.

In some embodiments, for example, the interactive game includes a combined list of vocabulary words, which is created based on: a first list of vocabulary words that the student mastered in a first time period ending at the creation of the combined list of vocabulary words, and a second list of vocabulary words that the student mastered in a second time period ending prior to the beginning of the first time period.

In some embodiments, for example, the method includes: creating said combined list of vocabulary words based on: the first list of vocabulary words sorted based on respective recycling counters, and the second list of vocabulary words sorted based on respective recycling counters.

In some embodiments, for example, approximately half of vocabulary words in the combined list are included in the first list, and wherein approximately half of vocabulary words in the combined list are included in the second list.

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 41 is a schematic block diagram illustration of a teaching/learning system in accordance with some demonstrative embodiments.

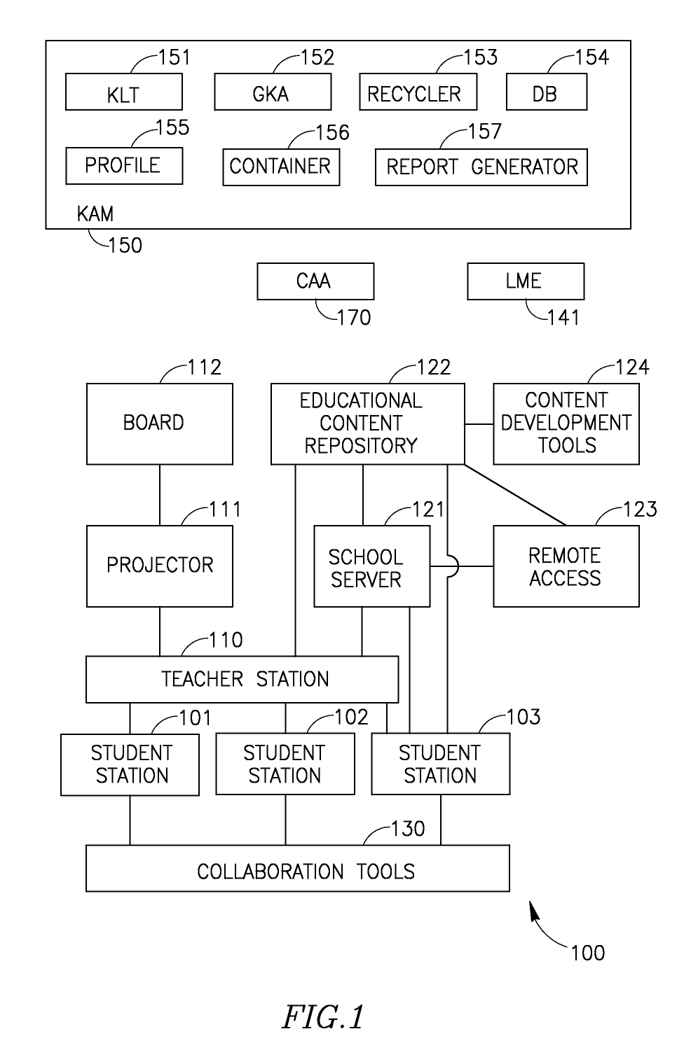

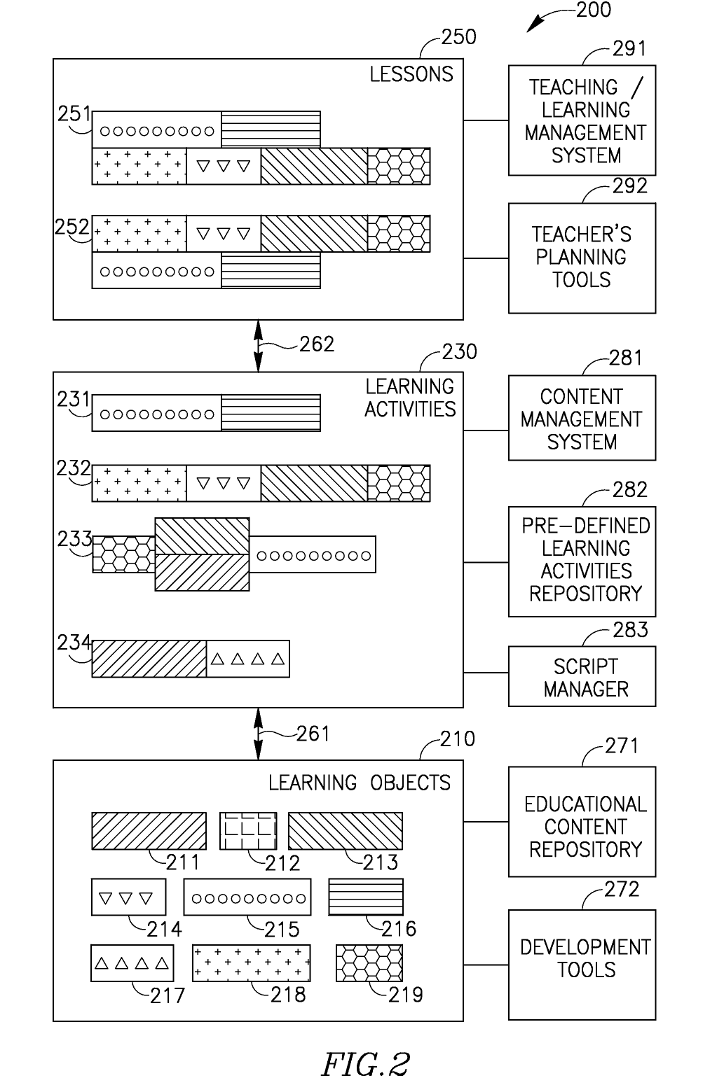

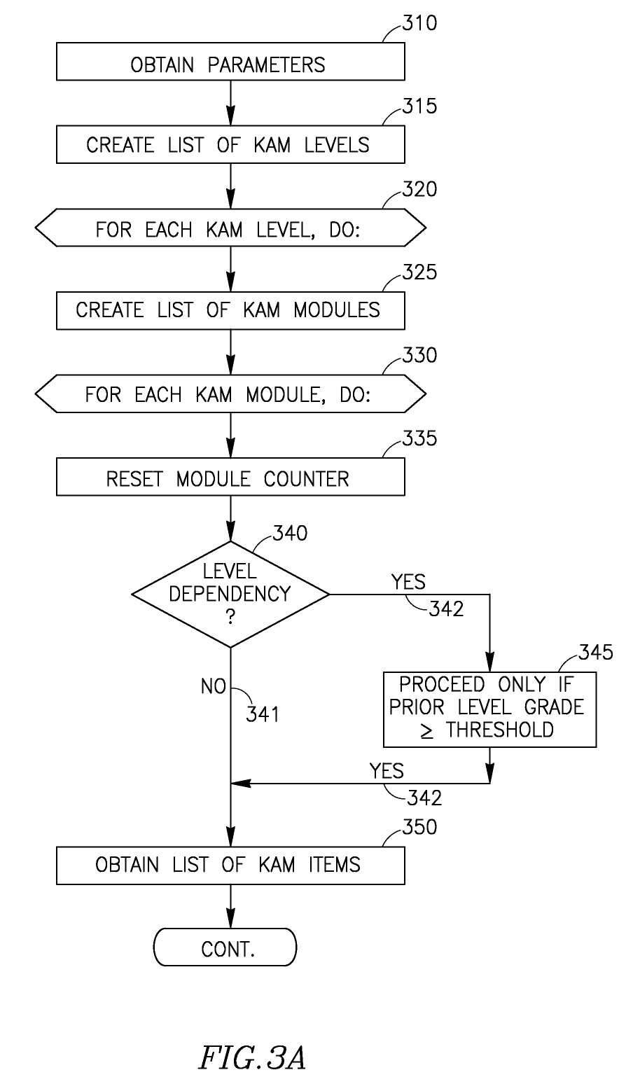

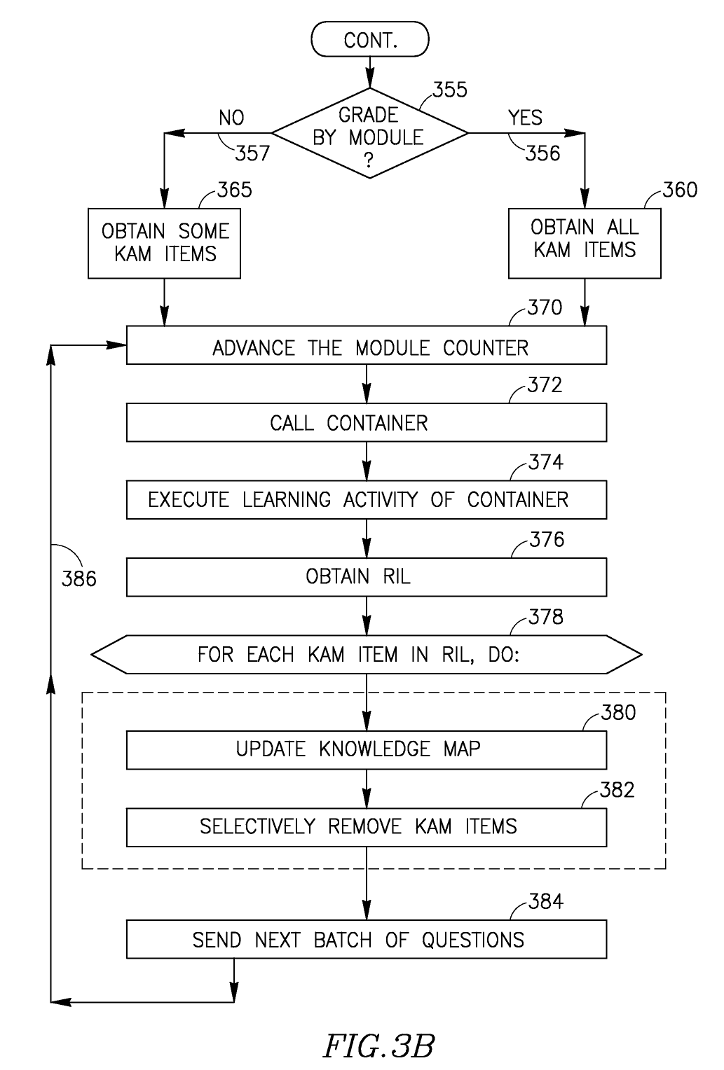

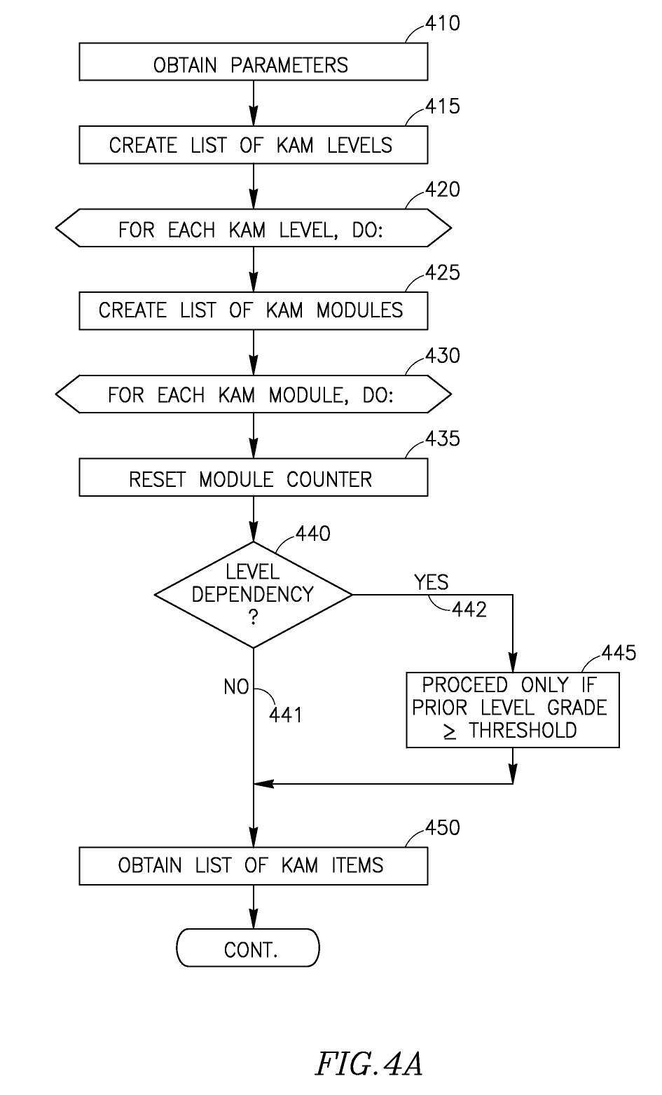

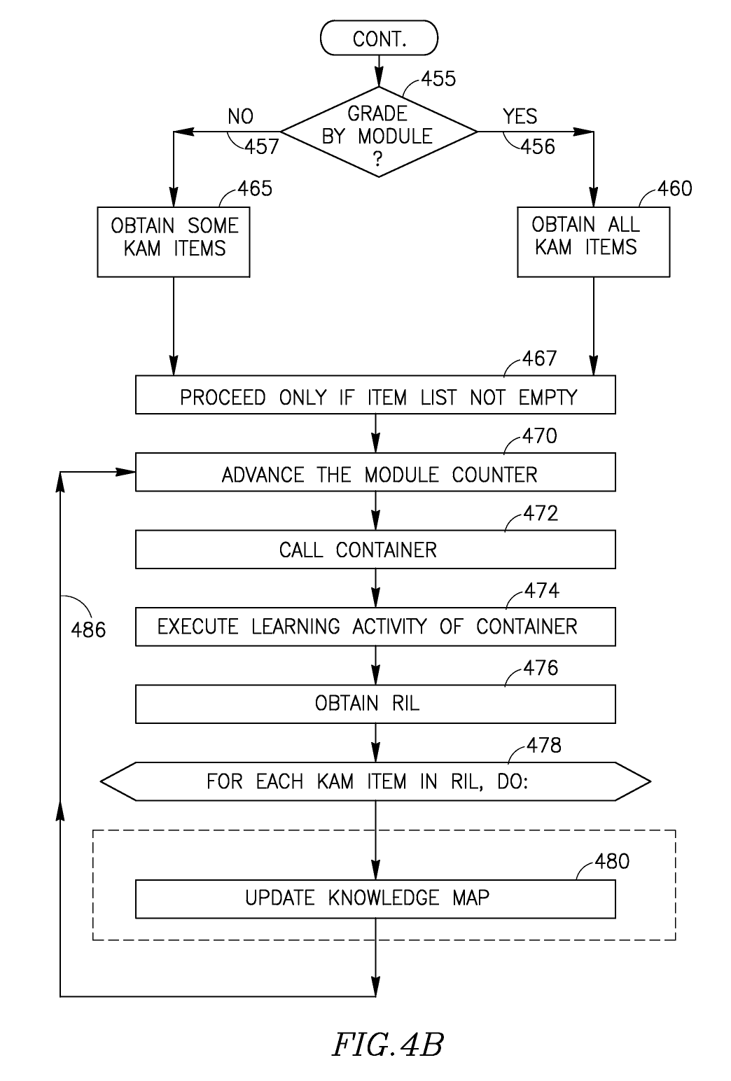

FIG. 2 is a schematic block diagram illustration of a teaching/learning data structure in accordance with some demonstrative embodiments.

FIGS. 3A-3B are a schematic flow-chart of a method of knowledge level testing, in accordance with some demonstrative embodiments.

FIGS. 4A-4B are a schematic flow-chart of a method of guided knowledge acquisition, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The terms “plurality” or “a plurality” as used herein include, for example, “multiple” or “two or more”. For example, “a plurality of items” includes two or more items.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

The term “teacher” as used herein includes, for example, an educator, a tutor, a guide, a principal, a permanent teacher, a substitute teacher, an instructor, a moderator, a supervisor, an adult supervising minors, a parent acting in a role of a teacher, a designated student acting in a role of a teacher, a coach, a trainer, a professor, a lecturer, an education-providing person, a member of an education system, a teaching professional, a teaching person, a member of an education system, a teacher that performs teaching activities in-class and/or out-of-class and/or remotely, a person that conveys information or knowledge to one or more students, or the like.

The term “student” as used herein includes, for example, a pupil, a minor student, an adult student, a scholar, a minor, an adult, a person that attends school on a regular or non-regular basis, a learner, a person acting in a learning role, a learning person, a person that performs learning activities in-class or out-of-class or remotely, a person that receives information or knowledge from a teacher, or the like.

The term “class” as used herein includes, for example, a group of students which may be in a classroom or may not be in the same classroom; a group of students which may be associated with a teaching activity or a learning activity; a group of students which may be spatially separated, over one or more geographical locations; a group of students which may be in-class or out-of-class; a group of students which may include student(s) in class, student(s) learning from their homes, student(s) learning from remote locations (e.g., a remote computing station, a library, a portable computer), or the like.

Some embodiments may be used in conjunction with one or more components, devices, systems and/or methods described in U.S. patent application Ser. No. 11/831,981, titled “Device, System, and Method of Adaptive Teaching and Learning”, filed on Aug. 1, 2007, which is hereby incorporated by reference in its entirety.

FIG. 1 is a schematic block diagram illustration of a teaching/learning system 100 in accordance with some demonstrative embodiments. Components of system 100 are interconnected using one or more wired and/or wireless links, e.g., utilizing a wired LAN, a wireless LAN, the Internet, and/or other communication systems.

System 100 includes a teacher station 110, and multiple student stations 101-103. The teacher station 110 and/or the student stations 101-103 may include, for example, a desktop computer, a Personal Computer (PC), a laptop computer, a mobile computer, a notebook computer, a tablet computer, a portable computer, a cellular device, a dedicated computing device, a general purpose computing device, or the like.

The teacher station 110 and/or the student stations 101-103 may include, for example: a processor (e.g., a Central Processing Unit (CPU), a Digital Signal Processor (DSP), a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller); an input unit (e.g., a keyboard, a keypad, a mouse, a touch-pad, a stylus, a microphone, or other suitable pointing device or input device); an output unit (e.g., a Cathode Ray Tube (CRT) monitor or display unit, a Liquid Crystal Display (LCD) monitor or display unit, a plasma monitor or display unit, a screen, a monitor, one or more speakers, or other suitable display unit or output device); a memory unit (e.g., a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units); a storage unit (e.g., a hard disk drive, a floppy disk drive, a Compact Disk (CD) drive, a CD-ROM drive, a Digital Versatile Disk (DVD) drive, or other suitable removable or non-removable storage units); a communication unit (e.g., a wired or wireless Network Interface Card (NIC) or network adapter, a wired or wireless modem, a wired or wireless receiver and/or transmitter, a wired or wireless transmitter-receiver or transceiver, a Radio Frequency (RF) communication unit or transceiver, or other units able to transmit and/or receive signals, blocks, frames, transmission streams, packets, messages and/or data; the communication unit may optionally include, or may optionally be associated with, one or more antennas or sets an antennas; an Operating System (OS); and other suitable hardware components and/or software components.

The teacher station 110, optionally utilizing a projector 111 and a board 112, may be used by the teacher to present educational subject matters and topics, to present lectures, to convey educational information to students, to perform lesson planning, to perform in-class lesson execution and management, to perform lesson follow-up activities or processes (e.g., review students performance, review homework, review quizzes, or the like), to assign learning activities to one or more students (e.g., on a personal basis and/or on a group basis), to conduct discussions, to assign homework, to obtain the personal attention of a student or a group of student, to perform real-time in-class teaching, to perform real-time in-class management of the learning activities performed by students or groups of students, to selectively allocate or re-allocate learning activities or learning objects to students or groups of students, to receive automated feedback or manual feedback from student stations 101-103 (e.g., upon completion of a learning activity or a learning object; upon reaching a particular grade or success rate; upon failing to reach a particular grade or success rate; upon spending a threshold amount of attempts or minutes with a particular exercise, or the like), or to perform other teaching and/or class management operations.

In some embodiments, the teacher station 110 may be used to perform operations of teaching tools, for example, lesson planning, real-time class management, presentation of educational content, allocation of differential assignment of content to students (e.g., to individual students or to groups of students), differential assignment of learning activities or learning objects to students (e.g., to individual students or to groups of students), adaptive assignment of content or learning activities or learning objects to students (e.g., based on their past performance in one or more learning activities, past successes, past failures, identified strengths, identified weaknesses), conducting of class discussions, monitoring and assessment of individual students or one or more groups of students, logging and/or reporting of operation performed by students and/or achievements of students, operating of a Learning Management System (LMS), managing of multiple learning processes performed (e.g., substantially in parallel or substantially simultaneously) by student stations 101-103, or the like. In some embodiments, some operations (e.g., logging operations) may be performed by a server (e.g., LMS server) or by other units external to the teacher station 110, whereas other operations (e.g., reporting operations) may be performed by the teacher station 110.

The teacher station 110 may be used in substantially real time (namely, during class hours and while the teacher and the students are in the classroom), as well as before and after class hours. For example, real time utilization of the teacher station includes: presenting topics and subjects; assigning to students various activities and assignments; conducting discussions; concluding the lesson; and assigning homework. Before and after class hours utilization include, for example: selecting and allocating educational content (e.g., learning objects or learning activities) for a lesson plan; guiding students; assisting students; responding to students questions; assessing work and/or homework of students; managing differential groups of students; and reporting.

The student stations 101-103 are used by students (e.g., individually such that each student operates a station, or that two students operate a station, or the like) to perform personal learning activities, to conduct personal assignments, to participate in learning activities in-class, to participate in assessment activities, to access rich digital content in various educational subject matters in accordance with the lesson plan, to collaborate in group assignments, to participate in discussions, to perform exercises, to participate in a learning community, to communicate with the teacher station 110 or with other student stations 101-103, to receive or perform personalized learning activities, or the like. In some embodiments, the student stations 101-103 may optionally include or utilize software components which may be accessed remotely by the student, for example, to allow the student to do homework from his home computer using remote access, to allow the student to perform learning activities or learning objects from his home computer or from a library computer using remote access, or the like. In some embodiments, student stations 101-103 may be implemented as “thin” client devices, for example, utilizing an Operating System (OS) and a Web browser to access remotely-stored educational content (e.g., through the Internet, an Intranet, or other types of networks) which may be stored on external and/or remote server(s).

The teacher station 110 is connected to, or includes, the projector 111 able to project or otherwise display information on a board 112, e.g., a blackboard, a white board, a curtain, a smart-board, or the like. The teacher station 110 and/or the projector 111 may be used by the teacher, to selectively project or otherwise display content on the board 112. For example, at first, a first content is presented on the board 112, e.g., while the teacher talks to the students to explain an educational subject matter. Then, the teacher may utilize the teacher station 110 and/or the projector 111 to stop projecting the first content, while the students use their student stations 101-103 to perform learning activities. Additionally, the teacher may utilize the teacher station 110 and/or the projector 111 to selectively interrupt the utilization of student stations 101-103 by students. For example, the teacher may instruct the teacher station 110 to send an instruction to each one of student stations 101-103, to stop or pause the learning activity and to display a message such as “Please look at the Board right now” on the student stations 101-103. Other suitable operations and control schemes may be used to allow the teacher station 110 to selectively command the operation of projector 111 and/or board 112.

The teacher station 110, as well as the student stations 101-103, may be connected with a school server 121 able to provide or serve digital content, for example, learning objects, learning activities and/or lessons. Additionally or alternatively, the teacher station 110, as well as the student stations 101-103, may be connected to an educational content repository 122, either directly (e.g., if the educational content repository 122 is part of the school server 121 or associated therewith) or indirectly (e.g., if the educational content repository 122 is implemented using a remote server, using Internet resources, or the like). In some embodiments, system 100 may be implemented such that educational content are stored locally at the school, or in a remote location. For example, a school server may provide full services to the teacher station 110 and/or the student stations 101-103; and/or, the school server may operate as mediator or proxy to a remote server able to serve educational content.

Content development tools 124 may be used, locally or remotely, to generate original or new education content, or to modify or edit or update content items, for example, utilizing templates, editors, step-by-step “wizard” generators, packaging tools, sequencing tools, “wrapping” tools, authoring tools, or the like.

In some embodiments, a remote access sub-system 123 is used, to allow teachers and/or students to utilize remote computing devices (e.g., at home, at a library, or the like) in conjunction with the school server 121 and/or the educational content repository 122.

In some embodiments, the teacher station 110 and the student stations 101-103 may be implemented using a common interface or an integrated platform (e.g., an “educational workstation”), such that a log-in screen request the user to select or otherwise input his role (e.g., teacher or student) and/or identity (e.g., name or unique identifier).

In some embodiments, system 100 performs ongoing assessment of students performance based on their operation of student stations 101-103. For example, instead of or in addition to conventional event-based quizzes or examinations, system 100 monitors the successes and the failures of individual students in individual learning objects or learning activities. For example, the teacher utilizes the teacher station 110 to allocate or distribute various learning activities or learning objects to various students or groups of students. The teacher utilizes the teacher station 110 to allocate a first learning object and a second learning object to a first group of students, including Student A who utilizes student station 101; and the teacher utilizes the teacher station 110 to allocate the first learning object and a third learning object to a second group of students, including Student B who utilizes student station 102.

System 100 monitors, logs and reports the performance of students based on their operation of student stations 101-103. For example, system 100 may determine and report that Student A successfully completed the first learning object, whereas Student B failed to complete the second learning object. System 100 may determine and report that Student A successfully completed the first learning object within a pre-defined time period associated with the first learning object, whereas Student B completed the second learning object within a time period longer than the required time period. System 100 may determine and report that Student A successfully completed or answered 87 percent of tasks or questions in a learning object or a learning activity, whereas Student B successfully completed or answered 45 percent of tasks or questions in a learning object or a learning activity. System 100 may determine and report that Student A successfully completed or answered 80 percent of the tasks or questions in a learning object or a learning activity on his first attempt and 20 percent of tasks or questions only on the second attempt, whereas Student B successfully completed or answered only 29 percent on the first attempt, 31 percent on the second attempt, and for the remaining 40 percent he got the right answer from the student station (e.g., after providing incorrect answers on three attempts). System 100 may determine and report that Student A appears to be “stuck” or lingering on a particular exercise or learning object, or that Student B did not operate the keyboard or mouse for a particular time period (e.g., two minutes). System 100 may determine and report that at least 80 percent of the students in the first group successfully completed at least 75 percent of their allocated learning activity, or that at least 50 percent of the students in the second group failed to correctly answer at least 30 percent of questions allocated to them. Other types of determinations and reports may be used.

System 100 generates reports at various times and using various methods, for example, based on the choice of the teacher utilizing the teacher station 110. For example, the teacher station 110 may generate one or more types of reports, e.g., individual student reports, group reports, class reports, an alert-type message that alerts the teacher to a particular event (e.g., failure or success of a student or a group of students), or the like. Reports may be generated, for example, at the end of a lesson; at particular times (e.g., at a certain hour); at pre-defined time intervals (e.g., every ten minutes, every school-day, every week); upon demand, request or command of a teacher utilizing the teacher station; upon a triggering event or when one or more conditions are met, e.g., upon completion of a certain learning activity by a student or group of students, a student failing a learning activity, a pre-defined percentage of students failing a learning activity, a student succeeding in a learning activity, a pre-defined percentage of students succeeding in a learning activity, or the like.

In some embodiments, reports or alerts may be generated by system 100 substantially in real-time, during the lesson process in class. For example, system 100 may alert the teacher, using a graphical or textual or audible notification through the teacher station 110, that one or more students or groups of students do not progress (at all, or according to pre-defined mile-stones) in the learning activity or learning object assigned to them. Upon receiving the real-time alert, the teacher may utilize the teacher station 110 to further retrieve details of the actual progress, for example, by obtaining detailed information on the progress of the relevant student(s) or group(s). For example, the teacher may use the teacher station 110 to view a report detailing progress status of students, e.g., whether the student started or not yet started a learning object or a learning activity; the percentage of students in the class or in one or more groups that completed as assignment; the progress of students in a learning object or a learning activity (e.g., the student performed 40 percent of the learning activity; the student is “stuck” for more than three minutes in front of the third question or the fourth screen of a learning object; the student completed the assigned learning object, and started to perform an optional learning object), or the like.

In some embodiments, teaching, learning and/or assessment activities are monitored, recorded and stored in a format that allows subsequent searching, querying and retrieval. Data mining processes in combination with reporting tools may perform research and may generate reports on various educational, pedagogic and administrative entities, for example: on students (single student, a group of students, all students in a class, a grade, a school, or the like); teachers (a single teacher, a group of teachers that teach the same grade and/or in the same school and/or the same discipline); learning activities and related content; and for conducting research and formative assessment for improvement of teaching methodologies, flow or sequence of learning activities, or the like.

In some embodiments, data mining processes and analysis processes may be performed, for example, on knowledge maps of students, on the tracked and logged operations that students perform on student stations, on the tracked and logged operations that teachers perform on teacher stations, or the like. The data mining and analysis may determine conclusions with regard to the performance, the achievements, the strengths, the weaknesses, the behavior and/or other properties of one or more students, teachers, classes, groups, schools, school districts, national education systems, multi-national or international education systems, or the like. In some embodiments, analysis results may be used to compare among teaching and/or learning at international level, national level, district level, school level, grade level, class level, group level, student level, or the like.

In some embodiments, the generated repots are used as alternative or additional assessment of students performance, students knowledge, students knowledge, students learning strategies (e.g., a student is always attempting trial and error when answering; a student is always asking the system for the hint option), students classroom behavior (e.g., a student is responsive to instructions, a student is non-responsive to instructions), or other student parameters. In some embodiments, for some assessment events, information items (e.g., “rubrics”) may be created and/or displayed, to provide assessment-related information to the teacher or to the teaching/learning system; the assessment information item may be visible to, or accessible by, the teacher and/or the student (e.g., subject to teacher's authorization). The assessment information item may include, for example, a built-in or integrated information item inside an assessment event that provides instructions to the teacher (or the teaching/learning system) on how to evaluate an assessment event which was executed by the student. Other formats and/or functions of assessment information items may be used.

Optionally, system 100 generates and/or initiates, automatically or upon demand of the teacher utilizing the teacher station 110 (or, for example, automatically and subject to the approval of the teacher utilizing the teacher station 110), one or more student-adapted correction cycles, “drilling” cycles, additional learning objects, modified learning objects, or the like. In view of data from of the students' record of performance, system 100 may identify strengths and weaknesses, comprehension and misconceptions. For example, system 100 determines that Student A solved correctly 72 percent of the math questions presented to him; that substantially all (or most of) the math questions that Student A solved successfully are in the field of multiplication; and that substantially all (or most of) the math questions that Student A failed to solved are in the field of division. Accordingly, system 100 may report to the teacher station 110 that Student A comprehends multiplication, and that Student A does not comprehend (at all, or to an estimated degree) division. Additionally, system 100 adaptively and selectively presents content (or refrain from presenting content) to accommodate the identified strengths and weaknesses of Student A. For example, system 100 may selectively refrain from presenting to Student A additional content (e.g., hints, explanations and/or exercises) in the field of multiplication, which Student A comprehends. System 100 may selectively present to Student A additional content (e.g., explanations, examples and/or exercises) in the field of division, which Student B does not yet comprehend. The additional presentation (or the refraining from additional presentation) may be performed by system 100 automatically, or subject to an approval of the teacher utilizing the teacher station 110 in response to an alert message or a suggestion message presented on the teacher station 110.

In some embodiments, if given the appropriate permission(s), multiple types of users may utilize system 100 or its components, in-class and/or remotely. Such types of users include, for example, teachers in class, students in class, teachers at home or remotely, students at home or remotely, parents, community members, supervisors, managers, principals, authorities (e.g., Board of Education), school system administrator, school support and help-desk personnel, system manager(s), techno-pedagogic experts, content development experts, or the like.

In some embodiments, system 100 may be used as a collaborative Learning Management System (LMS), in which teachers and students utilize a common system. For example, system 100 may include collaboration tools 130 to allow real-time in-class collaboration, e.g., allowing students to send or submit their accomplishments or their work results (or portions thereof) to a common space, from which the teacher (utilizing the teacher station 110) selects one or more of the submission items for projection, for comparison, or the like. The collaboration tools 130 may optionally be implemented, for example, using a collaboration environment or collaboration area or collaboration system. The collaboration tools 130 may optionally include a teacher-moderated common space, to which students (utilizing the student stations 101-103) post their work, text, graphics, or other information, thereby creating a common collaborative “blog” or publishing a Web news bulletin or other form of presentation of students products. The collaboration tools 130 may further provide a collaborative workspace, where students may work together on a common assignment, optionally displaying in real-time peers that are available online for chat or instant messaging (e.g., represented using real-life names, user-names, avatars, graphical items, textual items, photographs, links, or the like).

In some embodiments, dynamic personalization and/or differentiation may be used by system 100, for example, per teacher, per student, per group of students, per class, per grade, or the like. System 100 and/or its educational content may be open to third-party content, may comply with various standards (e.g., World Wide Web standards, education standards, or the like). System 100 may be a tagged-content Learning Content Management System (LCMS), utilizing Semantic Web mechanisms, meta-data, tagging content and learning activities by concept-based controlled vocabulary, describing their relations to educational and/or disciplinary concepts, and/or democratic tagging of educational content by users (e.g., teachers, students, experts, parents, or the like).

System 100 may utilize or may include pluggable architecture, for example, a plug-in or converter or importer mechanism, e.g., to allow importing of external materials or content into the system as learning objects or learning activities or lessons, to allow smart retrieval from the content repository, to allow identification by the LMS system and the CAA sub-system, to allow rapid adaptation of new types of learning objects (e.g., original or third-party), to provide a blueprint or a template for third-party content, or the like.

System 100 may be implemented or adapted to meet specific requirements of an education system or a school. For example, in some embodiments, system 100 may set a maximum number of activities per sequence or per lesson; may set a maximum number of parallel activities that the teacher may allocate to students (e.g., to avoid a situation in which the teacher “loses control” of what each student in the class is doing); may allow flexible navigation within and/or between learning activities and/or learning objects; may include clear, legible and non-artistic interface components, for easier or faster comprehension by users; may allow collaborative discussions among students (or student stations), and/or among one or more students (or student stations) and the teacher (or teacher station); and may train and prepare teacher and students for using the system 100 and for maximizing the benefits from its educational content and tools.

In some embodiments, a student station 101-103 allows the student to access a “user cabinet” or “personal folder” which includes personal information and content associated with that particular student. For example, the “user cabinet” may store and/or present to the student: educational content that the student already viewed or practiced; projects that the student already completed and/or submitted; drafts and work-in-progress that the student prepares, prior to their completion and/or submission; personal records of the student, for example, his grades and his attendance records; copies of tests or assignments that the student already took, optionally reconstructing the test or allowing the test to be re-solved by the student, or optionally showing the correct answers to the test questions; lessons that the student already viewed; tutorials that the student already viewed, or tutorials related to topics that the student already practiced; forward-looking tutorials, lectures and explanations related to topics that the student did not yet learn and/or did not yet practice, but that the student is required to learn by himself or out of class; assignments or homework assignments pending for completion; assignments or homework assignments completed, submitted, graded, and/or still in draft status; a notepad with private or personal notes that the student may write for his retrieval; indications of “bookmarks” or “favorites” or other pointers to learning objects or learning activities or educational content which the student selected to mark as favorite or for rapid access; or the like.

In some embodiments, the teacher station 110 allows the teacher (and optionally one or more students, if given appropriate permission(s), via the student stations) to access a “teacher cabinet” or “personal folder” (or a subset thereof, or a presentation or a display of portions thereof), which may, for example, store and/or present to the teacher (and/or to students) the “plans” or “activity layout” that the teacher planned for his class; changes or additions that the teacher introduced to the original plan; presentation of the actually executed lesson process, optionally including comments that the teacher entered; or the like.

System 100 may utilize Computer-Assisted Assessment or Computer-Aided Assessment (CAA) of performance of student(s) and of pedagogic parameters related to student(s). In some embodiments, for example, system 100 may include, or may be coupled to, a CAA sub-system 170 having multiple components or modules.

FIG. 2 is a schematic block diagram illustration of a teaching/learning data structure 200 in accordance with some demonstrative embodiments. Data structure 200 includes multiple layers, for example, learning objects 210, learning activities 230, and lessons 250. In some embodiments, the teaching/learning data structure 200 may include other or additional levels of hierarchy; for example, a study unit or a segment may include a collection of multiple lessons that cover a particular topic, issue or subject, e.g., as part of a yearly subject-matter learning/teaching plan. Other or additional levels of hierarchy may be used.

Learning objects 210 include, for example, multiple learning objects 211-219. A learning object includes, for example, a stand-alone application, applet, program, or assignment addressed to a student (or to a group of students), intended for utilization by a student. A learning object may be, for example, subject to viewing, listening, typing, drawing, or otherwise interacting (e.g., passively or actively) by a student utilizing a computer. For example, learning object 211 is an Active-X interactive animated story, in which a student is required to select graphical items using a pointing device; learning object 212 is an audio/video presentation or lecture (e.g., an AVI or MPG or WMV or MOV video file) which is intended for passive viewing/hearing by the student; learning object 213 is a Flash application in which the student is required to move (e.g., drag and drop) graphical object and/or textual objects; learning object 214 is a Java applet in which the student is required to type text in response to questions posed; learning object 215 is a JavaScript program in which the student selects answers in a multiple-choice quiz; learning object 216 is a Dynamic HTML page in which the student is required to read a text, optionally navigating forward and backward among pages; learning object 217 is a Shockwave application in which the student is required to draw geometric shapes in response to instructions; or the like. Learning objects may include various other content items, for example, interactive text or “live text”, writing tools, discussion tools, assignments, tasks, quizzes, games, drills and exercises, problems for solving, questions, instruction pages, lectures, animations, audio/video content, graphical content, textual content, vocabularies, or the like.

Learning objects 210 may be associated with various time-lengths, levels of difficulty, curriculum portions or subjects, or other properties. For example, learning object 211 requires approximately twelve minutes for completion, whereas learning object 212 requires approximately seven minutes for completion; learning object 213 is a difficult learning object, whereas learning object 214 is an easy learning object; learning object 215 is a math learning object, whereas learning object 216 is a literature learning object.

Learning objects 210 are stored in an educational content repository 271. Learning objects 271 are authored, created, developed and/or generated using development tools 272, for example, using templates, editors, authoring tools, a step-by-step “wizard” generation process, or the like. The learning objects 210 are created by one or more of: teachers, teaching professionals, school personnel, pedagogic experts, academy members, principals, consultants, researchers, or other professionals. The learning objects 210 may be created or modified, for example, based on input received from focus groups, experts, simulators, quality assurance teams, or other suitable sources. The learning objects 210 may be imported from external sources, e.g., utilizing a conversion or re-formatting tools. In some embodiments, modification of a learning object by a user may result in a duplication of the learning object, such that both the original u-modified version and the new modified version of the learning object are stored; the original version and the new version of the learning object may be used substantially independently.

Learning activities 230 include, for example, multiple learning activities 231-234. For example, learning activity 231 includes learning object 215, followed by learning object 216. Learning activity 232 includes learning object 218, followed by learning objects 214, 213 and 219. Learning activity 233 includes learning object 233, followed by either learning object 213 or learning object 211, followed by learning object 215. Learning activity 234 includes learning object 211, followed by learning object 217.

A learning activity includes, for example, one or more learning objects in the same (or similar) subject matter (e.g., math, literature, physics, or the like). Learning activities 230 may be associated with various time-lengths, levels of difficulty, curriculum portions or subjects, or other properties. For example, learning activity 231 requires approximately eighteen minutes for completion, whereas learning activity 232 requires approximately thirty minutes for completion; learning activity 232 is a difficult learning activity, whereas learning activity 234 is an easy learning activity; learning activity 231 is a math learning activity, whereas learning activity 232 is a literature learning activity. A learning object may be used or placed at different locations (e.g., time locations) in different learning activities. For example, learning object 215 is the first learning object in learning activity 231, whereas learning object 215 is the last learning object in learning activity 233.

Learning activities 230 are generated and managed by a content management system 281, which may create and/or store learning activities 230. For example, browser interface allows a teacher to browse through learning objects 210 stored in the educational content repository (e.g., sorted or filtered by subject, difficulty level, time length, or other properties), and to select and construct a learning activity by combining one or more learning objects (e.g., using a drag-and-drop interface, a time-line, or other tools). In some embodiments, learning activities 230 can be arranged and/or combined in various teaching-learning-assessment scenarios or layouts, for example, using different methods of organization or modeling methods. Scenarios may be arranged, for example, manually in a pre-defined order; or may be generated automatically utilizing a script to define sequencing, branched sequencing, conditioned sequencing, or the like. Additionally or alternatively, pre-defined learning activities are stored in a pre-defined learning activities repository 282, and are available for utilization by teachers. In some embodiments, an edited scenario or layout, or a teacher generated scenario or layout, are stored in the teacher's personal “cabinet” or “private folder” (e.g., as described herein) and can by recalled for re-use or for modification. In some embodiments, other or additional mechanisms or components may be used, in addition to or instead of the learning activities repository 282. The teaching/learning system provides tools for editing of pre-defined scenarios (e.g., stored in the learning activities repository 282), and/or for creation of new scenarios by the teacher. For example, a script manager 283 may be used to create, modify and/or store scripts which define the components of the learning activity, their order or sequence, an associated time-line, and associated properties (e.g., requirements, conditions, or the like). Optionally, scripts may include rules or scripting commands that allow dynamic modification of the learning activity based on various conditions or contexts, for example, based on past performance of the particular student that uses the learning activity, based on preferences of the particular student that uses the learning activity, based on the phase of the learning process, or the like. Optionally, the script may be part of the teaching/learning plan. Once activated or executed, the script calls the appropriate learning object(s) from the educational content repository 271, and may optionally assign them to students, e.g., differentially or adaptively. The script may be implemented, for example, using Educational Modeling Language (EML), using scripting methods and commands in accordance with IMS Learning Design (LD) specifications and standards, or the like. In some embodiments, the script manager 283 may include an EML editor, thereby integrating EML editing functions into the teaching/learning system. In some embodiments, the teaching/learning system and/or the script manager 283 utilize a “modeling language” and/or “scripting language” that use pedagogic terms, e.g., describing pedagogic events and pedagogic activities that teachers are familiar with. The script may further include specifications as to what type of data should be stored or reported to the teacher substantially in real time, for example, with regard to students interactions or responses to a learning object. For example, the script may indicate to the teaching/learning system to automatically perform one or more of these operations: to store all the results and/or answers provided by students to all the questions, or to a selected group of questions; to store all the choices made by the student, or only the student's last choice; to report in real time to the teacher if pre-defined conditions are true, e.g., if at least 50 percent of the answers of a student are wrong; or the like.

Lessons 250 include, for example, multiple lessons 251 and 252. For example, lesson 251 includes learning activity 231, followed by learning activity 232. Lesson 252 includes learning activity 234, followed by learning activity 231. A lesson includes one or more learning activities, optionally having the same (or similar) subject matter.

For example, learning objects 211 and 217 are in the subject matter of multiplication, whereas learning objects 215 and 216 are in the subject matter of division. Accordingly, learning activity 234 (which includes learning objects 211 and 217) is in the subject matter of multiplication, whereas learning activity 231 (which includes learning objects 215 and 216) is in the subject matter of division. Furthermore, lesson 252 (which includes learning activities 234 and 231) is in the subject matter of math.

Lessons 250 may be associated with various time-lengths, levels of difficulty, curriculum portions or subjects, or other properties. For example, lesson 251 requires approximately forty minutes for completion, whereas lesson 252 requires approximately thirty five for completion; lesson 251 is a difficult lesson, whereas lesson 252 is an easy lesson. A learning activity may be used or placed at different locations (e.g., time locations) in different lessons. For example, learning activity 215 is the first learning object in learning activity 231, whereas learning object 215 is the last learning object in learning activity 233.

Lessons 250 are generated and managed by a teaching/learning management system 291, which may create and/or store lessons 250. For example, browser interface allows a teacher to browse through learning activities 230 (e.g., sorted or filtered by subject, difficulty level, time length, or other properties), and to select and construct a lesson by combining one or more learning activities (e.g., using a drag-and-drop interface, a time-line, or other tools). Additionally or alternatively, pre-defined lessons may be available for utilization by teachers.

As indicated by an arrow 261, learning objects 210 are used for creation and modification of learning activities 230. As indicated by an arrow 262, learning activities are used for creation and modification of lessons 250.

In some embodiments, a large number of learning objects 210 and/or learning activities 230 are available for utilization by teachers. For example, in one embodiment, learning objects 210 may include at least 300 singular learning objects 210 per subject per grade (e.g., for second grade, for third grade, or the like); at least 500 questions or exercises per subject per grade; at least 150 drilling games per subject per grade; at least 250 “live text” activities (per subject per grade) in which students interact with interactive text items; or the like.

Some learning objects 210 are originally created or generated on a singular basis, such that a developer creates a new, unique learning object 210. Other learning objects 210 are generated using templates or generation tools or “wizards”. Still other learning objects 210 are generated by modifying a previously-generated learning object 210, e.g., by replacing text items, by replacing or moving graphical items, or the like.

In some embodiments, one or more learning objects 210 may be used to compose or construct a learning activity; one or more learning activities 230 may be used to compose or construct a lesson 250; one or more lessons may be part of a study unit or an educational topic or subject matter; and one or more study units may be part of an educational discipline, e.g., associated with a work plan.

Referring back to FIG. 1, system 100 may include a Learning Management Engine (LME) 141, which may be implemented as part of school server 121 or as a separate component, and may perform one or more of the learning management operations discussed herein.

System 100 may further include a Knowledge Acquisition Machine (KAM) 150 able to assess, improve and practice a student' proficiency in a given subject matter. The KAM 150 may include, for example, a Knowledge Level Test (KLT) component 151, for testing of student knowledge level; a Guided Knowledge Acquisition (GKA) component 152 for teaching knowledge; and a recycler component 153 for practicing knowledge. Each component of KAM 150 may be may be independent and may be selectively assigned to students by the teacher.

Results of activities performed using the KLT component 151 are logged and stored in a database 154. Combinations of questions that were answered incorrectly by the student, per difficulty level and/or per modality, may be taught and practiced using the GKA component 152. Combinations of questions that were answered correctly by the student, per difficulty level and/or per modality, may be further practiced using the recycler component 153, e.g., through learning activities and/or games.

When utilizing the KLT component 151 and the GKA component 152, students will work their way across the different modalities. For each modality, students progress from one difficulty level to another. Each combination of modality and difficulty level includes multiple questions.

In some embodiments, KAM 150 may be implemented per discipline. For example, system 100 may include a math KAM 150, language arts KAM 150, a second-language or foreign-language KAM 150, or the like. For demonstrative purposes, portions of the discussion herein may relate to a “Math KAM” and/or to an “English KAM”; other suitable disciplines may have KAMs associated therewith.

Each KAM 150 may be used, for example, to allow differentiated learning; to increase study time; to close students gaps in different basic areas; to allow performance of learning activities without teacher's involvement; to allow assessment and monitoring of a student's knowledge and progress in knowledge acquisition; and to follow one or more pedagogic standards or curriculum targets. The KAM 150 may support evaluating, acquiring and maintaining knowledge on various disciplines and modalities; and may provide the teacher with information regarding student's knowledge and progress. The KAM 150 may be used frequently, e.g., daily; and the content practiced using the KAM 150 may not necessarily be related to the content studied in the study unit. In some embodiments, KAM 150 activities may be accessed by students remotely, for example, from their home.

Each study unit of a subject matter may be divided into multiple difficulty levels, each containing a number of items. The difficulty levels are further divided into modules, each including specific characterizations of the item. The KAM 150 allows the teacher to set a KAM profile 155 per student, indicating the student's initial level for KAM activities; and the KAM profile 155 may subsequently be modified by the teacher. The KAM profile 155 is used by the KAM 150 to determine the KAM levels and modules that are presented to the student in the KAM activities. The KAM profile 155 may be visible and/or accessible through the teacher station only for students or classes associated with KAM disciplines and levels.

Some embodiments utilize a personalized modality (for example, in learning the Language Arts), which relates to the student's particular studying preferences and/or personal weaknesses (e.g., and not only to a difficulty level). For example, in the process of vocabulary acquisition (e.g., learning new words), some students are at a “core level” and will find it relatively easy to associate a picture with a name of the item shown in it, if this name is read-out to them (using audio output), utilizing a set of operations performed by the student on her station (e.g., seeing each word's image, clicking on the image, and hearing the relevant sound of the word's pronunciation). However, some students may find it relatively difficult to perform this association if the name is only written, and not read-out to them. This may apply, for example, to some “English Learners” (e.g., immigrants who utilize a special English learning program) and also to students that have physical and/or mental disabilities.

Additionally, some students may be at a more advanced level, and may find it relatively easy to write or type the item's name into a designated field; whereas other students may only be able to select the item's name from a written list of selectable words. This may apply, for example, to some Dyslectic students, or to students having some learning disabilities.

Differences in learning or practicing needs may stem from achievement levels or from other causes as demonstrated. The I(AM 150 accommodates such different learning needs. Once the student's KAM profile 155 includes not only his level but also an indication to such a problem or special need, the KAM 150 may dynamically present to the student the proper modality, for example, with or without audio narration, with or without a selectable word-bank, or the like.

Accordingly, a “modality” is a version or an instance of a learning object or learning activity or task, which is tailored-made or adapted to accommodate not only a suitable level of difficulty for a particular student, but also to accommodate one or more weaknesses of the student or learning preferences associated with the student; for example, by adding or omitting features of the learning object or learning activity or task, by modifying a length or a time-limit associated therewith, by adding or removing audio narration, by adding or removing subtitles or captions which may accompany narrated text, by providing or omitting a word-bank, by providing or removing various tools (e.g., an online calculator, an online ruler, an online dictionary, a glossary, an online thesaurus, or other specific or general assistive tool), by adding or removing digital features such as selectable menus or “help bubbles” which appear when the mouse pointer “hovers” on an item (e.g., “on-mouse-over hovering”), or by otherwise providing a modified or adapted learning object or learning activity or task to accommodate the special needs, weaknesses, and/or learning preferences associated with a particular student.

The KAM 150 may be implemented as a generic system, discipline independent and component independent, thereby allowing additions and modifications of templates, layouts, levels, modules and disciplines without major changes to the LMS code base.

Each KAM activity may be implemented using a container 156 which receives input from the LME 141, for example: which KAM component 151-153 is to be activated; the discipline; the study unit; the KAM level and KAM module (e.g., based on student knowledge map and/or based on algorithms); list of KAM items (e.g., an item identification, an item path); or the like. During the execution of a KAM activity, the LME 141 may receive event data from the container 156, for example, for logging purposes and for further analysis and assessment. Subsequent to the KAM activity, the LME 141 may receive from the container 156 performance information, for example, KAM item identification and/or name, the student's grade per item (e.g., pass, fail, skipped by the student, or not tried by the student); exposure count; or the like.

In some embodiments, other and/or additional values may be used, instead of or in addition to “pass”, “fail”, “slip”, and “not tested”; for example, “passed in first attempt”, “passed in second attempt”, “passed in third attempt”, “failed in three attempts”, “passed after requesting and receiving a hint”, “partially solved” (e.g., if the student performs correctly a portion of the task, and performs incorrectly another portion of that task), “passed within the first half of the time allocated for responding”, “passed within the last third of the time allocated for responding”, or other suitable values which may subsequently be utilized or taken into account.

It is noted that container 156 is only a demonstrative example, and other architectures may be used in different implementations. For example, in some embodiments, a script may be used to “collect” or assemble, and optionally to configure or modify, the relevant components and/or educational content. In some embodiments, an “activity logic” or an “advancer” module or other flow-managing component or module may be used. Accordingly, discussions herein which relate, for demonstrative purposes, to a container or to container 156, may be relevant to other suitable type of activity logic or other suitable implementations.

The KAM 150 may utilize multiple tables and lists, to represent, for example: a student's knowledge map; KAM study units (e.g., one record per study unit per KAM component 151-153); KAM item data; grade enumeration; or the like. In some embodiments, KAM 150 may utilize pre-defined tables and lists, for example, indicating disciplines (e.g., Mathematics, English); indicating levels per discipline (e.g., core, advanced, expansion, enrichment); indicating modules (e.g., textual module, audio module, audio and textual module, meaning in context module, spelling focus module, grammar focus module); recycler activities and games (e.g., memory game, matching game, spelling game, puzzle game, assembly game, or one or more other games from an array of interactive games); or the like. The KAM 150 may utilize a student's knowledge map, which may be generated and/or updated by the LME 141; as well as KAM profiles, which similarly may be handled by the LME 141. A KAM item list may correspond to each study unit; and each KAM component 151-153 may be directly associated with a KAM item list. Optionally, a KAM item list may be shared by two or more of the KAM components 151-153, for example, across different segments. KAM item lists are handled by the LME 141, and include pointers to KAM item files, which in turn are handled by the container 156. In some embodiments, the LME 141 may communicate with the CAA sub-system 170, for example, to obtain from the CAA sub-system 170 information about the student (e.g., student profile, student competency level(s), or the like), and to report the student's progress for inclusion by the CAA sub-system in the student's personal acquired knowledge map. The KAM 150 may utilize data feeding based on pre-defined rules. For example, English disciplines “modalities” and math discipline “levels” may be fed to the KAM 150 as “modules”; whereas English discipline “word levels” and math discipline “modalities” may be fed to the KAM 150 as “modules”. The LME 141 may determine the KAM 150 study unit and/or item data. Each KAM item may be associated with one KAM level of a discipline; and with at least one KAM module of the discipline. In some embodiments, an English KAM may utilize KAM modules such as, for example, “spelling”, “grammar”, “meaning in context”, or the like; while the mathematics KAM may utilize KAM levels or modalities such as, for example, “number sense”, “pure calculation”, “calculation word problems”, “patterns”, “Algebraic Reasoning”, or the like.

In some embodiments, a KAM activity may be activated only if one or more prerequisites or conditions are met. For example, an English KAM module about “spelling” may be activated in the KLT component 151 or the GKA component 152 only if a “meaning in context” KAM module was performed by the student, and/or only if the student achieved a threshold score in the “meaning in context” KAM module.

In some embodiments, the KAM 150 may be associated with a report generator 157, which may generate, for example: a study unit report with a class view (corresponding to the current state or specific results of the KLT component 151); which may be zoomed-in to a KAM level report with a class view; which may be zoomed in to a study unit report with a student view.

In some embodiments, different threshold values may be defined (e.g., pre-defined and/or modified over time) per KAM module, per KAM level, per KAM profile, and/or per combinations thereof. In some embodiments, system 100 may automatically demote a student to a lower or to the lowest KAM module and/or KAM level upon her failure or continued failure (e.g., in a series of questions or learning activities, or over a pre-defined period of time); or may advance the student to an advanced or higher KAM module and/or KAM level upon her success or continued success.

In some embodiments, the KLT component 151 may utilize a state-saving mechanism, for example, to allow a student to pause and/or save a testing session, and to subsequently resume a paused testing session based on its saved state. In some embodiments, state-saving mechanisms may be used by KAM 150 in other cases in which a student fails to complete an assignment, for example, due to a power failure, network failure, communication failure, or the like.

In some embodiments, the KLT component 151 and/or other components of the KAM 150 may measure, log, analyze and/or utilize the time period that it takes a student to answer a question. For example, a determination that the student provides correct answers to questions relatively rapidly, may contribute to the overall achievement score of the student, or may otherwise be reflected in the student's score or advancement in the KAM 150.

The KAM 150 may be implemented as a comprehensive sub-system, which reveals and analyzes the student's knowledge map in particular subjects, followed by adaptive learning, practice and retaining of different subjects, e.g., as required by national or regional pedagogic standards or curriculums.

The KLT 151 may provide the student with an interactive test, based upon pedagogically defined materials, levels and modalities. The test may include multiple choice questions, and/or a “cloze” free-text typing question (e.g., to check spelling abilities). The student may not necessarily receive feedback for his performance at the testing phase. In some embodiments, audio/textual questions or audio/visual questions may be used, for example, questions in which an audio clip is played and then the student has to select a phrase or an image, or to enter a free-text answer. In some embodiments, the KLT 151 may allow the student only one trial for each question, and may optionally allow the student to “skip” a question (or a pre-defined number or percentage of questions).

The GKA component 152 may operate based upon the knowledge map for each student as created and/or updated by the LME 141 during or after the KLT stage. The LME 141 sends to the component GKA 152 the KAM Items, which are required to be taught, according to pedagogic standard(s) and the personal knowledge map.

In some embodiments, for each set of KAM items sent by the LME 141, a container 156 may be created to include, for example: an introductory screen having an animation which introduces the student to the modality; an exposure interactive screen which provides the student with the ability to learn words (or other educational content) without being evaluated, e.g., by seeing each word's image, clicking on the image, and hearing the relevant sound of the word's pronunciation; a transition screen having animation, to transit the student from the learning phase to the practice phase; practice screens having multiple-choice questions and/or “cloze” questions, in which the student answers questions and receives feedbacks, based upon his performance; optionally, one or more other, different, introductory screens in case of repeating and learning additional items in the same modality; and an ending screen, if there are no more items left to be learned by the student in the current modality.

In some embodiments, a question may be graded as “pass” only if the student provided the correct answer in his first trial. In other embodiments, a question may be graded as “fail” if the student provided an incorrect answer in her first trial, even if she provided a correct answer in her second or subsequent trial of that question. In still other embodiments, a question may be graded as “pass” if the student provided a correct answer within a pre-defined number of trials (e.g., smaller than the number of possible choices in a multiple-choice question).

The recycler component 153 may allow the student to maintain her previously acquired knowledge, by rehearsing KAM items using interactive games. The LME 141 sends KAM items which are compiled into an interactive game based upon the type of modality and discipline. For example, a memory game may be used for rehearsing the comparison of images to sounds, using an audio/visual modality.

The KAM 150 may support generic feedbacks that are defined for each KAM level and/or KAM modality (e.g., independent of the particular KAM items); which may optionally be overridden, replaced or augmented by unique feedbacks, which may be used per each particular KAM item.

The KAM 150 may utilize templates corresponding to question types, in order to dynamically create and present questions. For example, a question in mathematics may correspond to a combination of parameters, e.g., <“multiplication”, “calculation”, “level 1”, “question 3”) and may include a template utilizing the following dynamic fields or modifiable parameters: the prompt of the question (e.g., “Please solve the following equation:”); the number of add-ins (e.g., two); the number of digits for the first add-in (e.g., one digit); the number of digits for the second add-in (e.g., two digits); the number of regroupings (e.g., zero); a format or style for equation display (e.g., vertical); a true/false parameter indicating whether or not to provide a “hint” or other help to the student; and/or other suitable parameters or fields.

The KAM 150 may log, store and analyze the progress of the student in order to update his knowledge map. For example, for each combination of KAM modality, difficulty level, and question, the database 154 may store the specific question prompted to the student, as well as the current state of that question for that student (namely: pass; fail; slipped; or not tried yet, which may be the default state). In some embodiments, for each student, all history snapshots may be stored, to allow monitoring of the student's progress throughout the different I(AM activities. Additionally, all student information may be logged per question (e.g., number of trials, the student's answer, the time that it took the student to answer).

In some embodiments, the operation of the GKA component 152 may be generally similar to the operation of the KLT component 151, although particular differences still exist between the two components. For example, the KLT component 151 may allow only one trial per question, whereas the GKA component 152 may allow multiple trials per questions. In addition, the GKA component 152 may provide (and the KLT component 151 may not provide) to the student hints, help, or feedback. Other operational differences may be used.

Reference is made to FIGS. 3A-3B, which are a schematic flow-chart of a method of knowledge level testing, in accordance with some demonstrative embodiments. Operations of the method may be used, for example, by the KLT component 151 of FIG. 1, or by other suitable components.

For demonstrative purposes, a KAM “module” in FIGS. 3A-3B may correspond to a “modality” in the English KAM or to a difficulty level in the mathematics KAM; whereas a KAM “level” may correspond to a word level in the English KAM or to a modality in the mathematics KAM.

In some embodiments, modalities (or modules) may be ordered and/or utilized in accordance with a pre-defined order, or based on a pedagogical hierarchy, according to a pre-defined pedagogical taxonomy of a subject area or discipline, or the like.

In some embodiments, the method may include, for example, obtaining parameters (block 310). This may include obtaining of: the discipline (“D”); the study unit (“SU”); a threshold value (“TH”) (e.g., a value of 66 corresponding to a 66 percent threshold), indicating a threshold value for advancement; a batch size value (“BatchSize”) indicating the maximum batch of items to operate in each round of the container; a grade-by-module true/false parameter (“GradeByModule”) indicating whether the threshold is to be checked per module or per item; a level dependency true/false parameter (“LevelDependency”) indicating whether to check success in previous KAM level(s); and a KAM profile per student per discipline (“KP”).

In some embodiments, the method may include, for example, creating a list of KAM levels (“KLs”) according to the discipline D, based on the KAM profile KP. (box 315).

In some embodiments, the method may include, for example, performing the following set of operations for each KAM level KL (block 320).

In some embodiments, the method may include, for example, creating a list of KAM modules (“Ms”) according to the discipline D, based on the KAM level KL and the KAM profile KP (block 325).

In some embodiments, the method may include, for example, performing the following set of operations for each KAM module M (block 330).

In some embodiments, the method may include, for example, resetting a module counter parameter (“ModuleCounter”) (block 335).

In some embodiments, the method may include, for example, checking whether a level dependency exists (block 340).

If a level dependency does not exist (arrow 341), the method may include, for example, proceeding with the operations of block 350 and onward.

In contrast, if a level dependency exists (arrow 342), then the method may proceed with the operations of block 350 and onward only if the total grade of the current module at the prior level (namely, at the KL-1 level) is greater than or equal to the threshold value TH (block 345).

In some embodiments, the method may include, for example, obtaining a list of KAM items (“Kitems”) that are relevant for the current KAM module M and the current KAM level KL (block 350).

In some embodiments, the method may include, for example, checking whether the GradeByModule parameter is true or false (block 355).

If the GradeByModule parameter is true (arrow 356), then the method may include, for example: obtaining all the KAM items from the KAM item list Kitem, if the grade in a prerequisite module in the current KAM level is greater than or equal to the threshold value TH (block 360).

In contrast, if the GradeByModule parameter is false (arrow 357), then the method may include, for example: selectively obtaining only the KAM items from the KAM item list Kitem, for which the item grade in a prerequisite module is “pass” (block 365).

In some embodiments, the method may include, for example, advancing the module counter parameter (block 370).

In some embodiments, the method may include calling a container (block 372), for example, based on the parameters: the KAM component which calls the container (namely, the KLT component), the discipline D, the study unit SU, the KAM level KL, the KAM module M, the module counter parameter ModuleCounter, and the obtained KAM item list indicating a batch having a size of BatchSize.

In some embodiments, the method may include, for example, executing the learning activity of the container (block 374).

In some embodiments, the method may include, for example, upon termination of the activity of the containing, obtaining from the container a Returned Item List (“RIL”) (block 376). The RIL may include, for each KAM item, for example: unique identifier of KAM item, name of KAM item, grade achieved in the KAM item (pass, fail, skipped by the student, or not tried by the student (the default grade)), and an exposure count.

In some embodiments, the method may include, for example, performing a set of operations for each KAM item in the RIL (block 378). The set of operations may include, for example: updating the student knowledge map based on the returned item (block 380); and, if the GradeByModule parameter is true, or the grade in the returned item is other than “not tried”, then the returned item may be removed from the item list Kitem (block 382).

Upon completion of that set of operations for each KAM item in the RIL, the method may proceed by sending the next batch of questions (block 384) and proceeding with the operations of block 370 and onward (arrow 386).

Other suitable operations or sets of operations may be used.

Reference is made to FIGS. 4A-4B, which are a schematic flow-chart of a method of guided knowledge acquisition, in accordance with some demonstrative embodiments. Operations of the method may be used, for example, by the GKA component 152 of FIG. 1, or by other suitable components.

For demonstrative purposes, a KAM “module” in FIGS. 4A-4B may correspond to a “modality” in the English KAM or to a difficulty level in the mathematics KAM; whereas a KAM “level” may correspond to a word level in the English KAM or to a modality in the mathematics KAM.

In some embodiments, modalities (or modules) may be ordered and/or utilized in accordance with a pre-defined order, or based on a pedagogical hierarchy, according to a pre-defined pedagogical taxonomy of a subject area or discipline, or the like.

In some embodiments, the method may include, for example, obtaining parameters (block 410). This may include obtaining of: the discipline (“D”); the study unit (“SU”); a threshold value (“ TH”) (e.g., a value of 66 corresponding to a 66 percent threshold), indicating a threshold value for advancement; a batch size value (“BatchSize”) indicating the maximum batch of items to operate in each round of the container; a grade-by-module true/false parameter (“GradeByModule”) indicating whether the threshold is to be checked per module or per item; a level dependency true/false parameter (“LevelDependency”) indicating whether to check success in previous KAM level(s); a KAM profile per student per discipline (“KP”); and a Practice Failure Count parameter (“PFC”).

In some embodiments, the method may include, for example, creating a list of KAM levels (“KLs”) according to the discipline D, based on the KAM profile KP. (box 415).

In some embodiments, the method may include, for example, performing the following set of operations for each KAM level KL (block 420).

In some embodiments, the method may include, for example, creating a list of KAM modules (“Ms”) according to the discipline D, based on the KAM level KL and the KAM profile KP (block 425).

In some embodiments, the method may include, for example, performing the following set of operations for each KAM module M(block 430).

In some embodiments, the method may include, for example, resetting a module counter parameter (“ModuleCounter”) (block 435).

In some embodiments, the method may include, for example, checking whether a level dependency exists (block 440).

If a level dependency does not exist (arrow 441), the method may include, for example, proceeding with the operations of block 450 and onward.

In contrast, if a level dependency exists (arrow 442), then the method may proceed with the operations of block 450 and onward only if the total grade of the current module at the prior level (namely, at the KL-1 level) is greater than or equal to the threshold value TH (block 445).

In some embodiments, the method may include, for example, obtaining a list of KAM items (“Kitems”) that are relevant for the current KAM module M and the current KAM level KL (block 450).

In some embodiments, the method may include, for example, checking whether the GradeByModule parameter is true or false (block 455).

If the GradeByModule parameter is true (arrow 456), then the method may include, for example: obtaining all the KAM items from the KAM item list Kitem, if the grade in a prerequisite module in the current KAM level is greater than or equal to the threshold value TH, or if no module grade is greater than or equal to the threshold value TH, or if less than PFC of the module grades are smaller than the threshold value TH (block 460). In some embodiments, the PFC value is checked for the current learning session, not necessarily for past sessions.

In contrast, if the GradeByModule parameter is false (arrow 457), then the method may include, for example: selectively obtaining only the KAM items from the KAM item list Kitem, for which: at least one “pass” grade is associated with a prerequisite module; and with a condition that no “pass” grade is associated with the current module, and the number of “fail” grades for this KAM item is smaller than the value of PFC (block 465).

In some embodiments, the method may proceed with the operations of block 470 and onward, only if the item list is not empty, namely, if a count of the items in the item list is greater than zero (block 467).

In some embodiments, the method may include, for example, advancing the module counter parameter (block 470).

In some embodiments, the method may include calling a container (block 472), for example, based on the parameters: the KAM component which calls the container (namely, the GKA component), the discipline D, the study unit SU, the KAM level KL, the KAM module M, the module counter parameter ModuleCounter, and the obtained KAM item list indicating a batch having a size of BatchSize.

In some embodiments, the method may include, for example, executing the learning activity of the container (block 474).

In some embodiments, the method may include, for example, upon termination of the activity of the container, obtaining from the container a Returned Item List (“RIL”) (block 476). The RIL may include, for each KAM item, for example: unique identifier of KAM item, name of KAM item, grade achieved in the KAM item (pass, fail, slipped by the student, or not tried by the student (the default grade)), and an exposure count.

In some embodiments, the method may include, for example, performing a set of operations for each KAM item in the RIL (block 478). The set of operations may include, for example: updating the student knowledge map based on the returned item (block 480).

Upon completion of that set of operations for each KAM item in the RIL, the method may proceed with the operations of block 455 and onward (arrow 486).

Other suitable operations or sets of operations may be used.

Referring back to FIG. 1, a similar set of operations may be used by the recycler component 153. For example, a list of KAM modules may be created, based on discipline D and KAM profile KP. The list of modules may correspond to substantially all KAM levels, and may be in reverse order and not necessarily in the original order in which KAM modules were already used. Then, for each KAM module M, a module game is selected. If more than one game is available, then one game may be selected randomly or pseudo-randomly, or based on other criteria (e.g., select the least selected game). Upon selection of the game, N items (e.g., words) for recycling in this module game may be selected. If the number of items (words) available for selection is insufficient (e.g., is greater than the minimum number of items required by the game), than a different game may be selected. If a different game with a sufficient number of words is not available, then the method may notify the student that no further practice games are available at this time, and may refer the student to the teacher for additional tasks.

Upon selection of the N items for the game, a container is called by the recycler component 153, for example, based on the following parameters: the KAM component which calls the container (namely, the recycler component 153), the discipline D, the study unit SU, the KAM level KL, the KAM module M, the module counter parameter ModuleCounter, and the obtained KAM item list indicating a batch having a size of BatchSize. The learning activity of the container is executed; upon its termination, a Returned Item List (“RIL”) is obtained from the container (“RIL”). The RIL may include, for each KAM item, for example: unique identifier of KAM item, name of KAM item, grade achieved in the KAM item (pass, fail, skipped by the student, or not tried by the student (the default grade)), and an exposure count. Then, for each KAM item in the RIL, the student knowledge map is updated based on the returned item.

Selection of items (e.g., words, vocabulary words, or other knowledge items) for insertion into the game module may be performed using a dedicated algorithm. For example, a parameter denoted Min may indicate the minimum number of items that the game module requires; and a parameter denoted Max may indicate the maximum number of items that the game module allows. A first list of items is created by collecting substantially all items (e.g., from all levels, and from this week's study units) associated with a current state of “pass”; the first list of items is sorted in ascending order based on recycling counters of the items. Similarly, a second list of items is created by collecting substantially all items (e.g., from all levels, and from the previous week's study unit) associated with a current state of “pass”; the second list of items is sorted in ascending order based on recycling counters of the items. If the sum of the number of items in the first list and the number of the items in the second list is equal to or greater than Min, then selection of items may be performed. For example, N denotes the minimum between: Max, and the sum of the number of items in the first list and the number of items in the second list. From each list, the first N/2 numbers are collected for the game module. If one of the two lists includes less than N/2 items, then all the items from that list are collected for the game module, and the collection is completed from the other list until N items are reached. If N is an odd number, then (N−1)/2 items may be collected from this week's items, and (N+1)/2 items may be collected from last week's items (or vice versa). Other suitable selection methods may be used. Similar operations and/or method may be used, not only for selection of words or vocabulary items, but also for selection of other knowledge items, questions, tasks, assets, or the like.

In some embodiments, other suitable algorithms may be used. For example, the algorithm reflected in Code 1 may be used by the KLT component 151, demonstrated herein with reference to “multiplication” in mathematics, and with reference to three KAM levels (denoted level 1, level 2, and level 3):

Code 1

| | |
|---|---|
| 1 | Initialize all current state of all <“multiplication”, modality, difficulty |
| | level, question> combinations to be NT (Not Tested) |
| 2 | Reset to zero all PFC counters of all (“multiplication”, modality, |
| | difficulty level> |
| 3 | For each modality (progress in order specified in Modality Table, |
| | and test only the relevant modalities), do: |
| 4 | { |
| 5 | For each level 1 question, run TEST |
| 6 | If passed at least Threshold percent of level 1 questions: |
| 7 | For each level 2 question, run TEST |
| 8 | If passed at least Threshold percent of level 2 questions: |
| 9 | For each level 3 question, run TEST |
| 10 | } |

The “TEST” action of Code 1 may be implemented per combinations of, for example, arithmetic operation (e.g., “multiplication”), modality, difficulty level, and question. Each test action may be activated only once per particular combination. The student may be prompted with a question that includes random or pseudo-random numbers, and may be allowed only one trial and no feedback. The current state may be updated to “pass” if the student provided the correct answer; to “fail” if the student provided an incorrect answer; and to “skip” if the student slipped the question (e.g., in some embodiments which allow the student to skip questions in the KLT phase).

In some embodiments, the algorithm reflected in Code 2 may be used by the GKA component 152, demonstrated herein with reference to “multiplication” in mathematics:

Code 2

| | |
|---|---|
| 20 | For each modality M (progress based on Modality table order), do: |
| 21 | For each difficulty level L (start with difficulty level 1), do: |
| 22 | { |
| 23 | If student passed less than Threshold percent of questions |
| | in modality M and level L |
| 24 | Run GKA machine on <modality M, difficulty level L> |
| 25 | If student passed at least Threshold percent of questions |
| | in modality M and difficulty level L, |
| 26 | Move to the next difficulty level (L+1) |
| 27 | Otherwise, move to the next modality (M+1) |
| 28 | } |

Referring to line 23 of Code 2, for each level of difficulty and modality, the GKA machine is activated either until the student passes at least Threshold percent of the questions associated with this modality and difficulty level, or until the difficulty level has been failed for a pre-defined number of times (e.g., three times). A student is defined as “passed” the question if the current state value f the question is “pass”; and not “fail”, “not tried”, or “skipped”.

Referring to line 24 of Code 2, the GKA machine may be run per combination of modality and difficulty level, using the demonstrative algorithm reflected in Code 3:

Code 3

| | |
|---|---|
| 30 | If (PFC=3), return to GKA algorithm |
| 31 | Display a general tutorial (if available) |
| 32 | For all questions in modality M and difficulty level L, do: |
| 33 | { |
| 34 | Practice (activate question; randomly generate numbers based on |
| | question type; allow two trials; allow hints and help based on |
| | question type) |
| 35 | If student answered correctly the question in her first trial, |
| | update to PASS the student’s current state <modality, difficulty |
| | level, question> |
| 36 | If student did not correctly answer the question in first trial, |
| | update to FAIL the student’s current state <modality, difficulty |
| | level, question> |
| 37 | If student skipped the question, |
| | update to SKIP the student’s current state <modality, difficulty |
| | level, question> |
| 38 | } |
| 39 | If student passed at least Threshold percent of questions |
| | in this modality and difficulty level, |
| 40 | Then reset PFC to 0 |
| 41 | Else, increment PFC by 1 |
| 42 | Return to GKA algorithm |

In some embodiments, the GKA component 152 may be used to practice modalities and difficulty levels in which the student did not pass the defined threshold percentage value (e.g., 70 percent). In the GKA stage, students are presented with questions associated with the relevant modality and difficulty level combination. A specific tutorial may optionally be available to the student. In addition, a mini-tutorial on a general subject may be available when relevant. In some embodiments, for each question, the student may be entitled to two trials, after which the GKA component 152 may reveal to the student the correct answer.

In some embodiments, a Practice Failure Counter (PFC) is defined for each combination of modality and difficulty level. The PFC is initialized to a value of zero, and is incremented by one upon each failure. Upon a third failure in of a <modality, difficulty level> combination, the student is stopped from further practicing this combination (e.g., to avoid student frustration).

At the end of the GKA activity, a student may have one of four values for each relevant combination of <modality, difficulty level, question> stored in the student's current state: “pass” (e.g., if student answered the question correctly at the first trial), “fail” (if the student answered the question incorrectly at the first trial), “NT” (not tried/not tested) (if the student did not reach the question), or “skip” (if the student skipped the question). GKA activity results, including current results and past results, are stored in the database 154 for further analysis.

Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution.

Some embodiments may be utilized by students of various ages or age groups, or by students belonging to various types of student groups; for example, school students, preschool students, high school students, college students, university students, students of a foreign language or a second foreign language, immigrant students, students with special needs, challenged students, advanced students, or a combination thereof. Some embodiments may be used to provide adaptive and differential teaching and learning to a heterogeneous group of students, in which a first subset of students has a first set of characteristics (or strengths, or weaknesses), whereas a second subset of students has a second set of characteristics (or strength, or weaknesses).

Although portions of the discussion herein may relate, for demonstrative purposes, to utilizing, determining and/or taking into account personal weaknesses of students, some embodiments may similarly utilize, determine and/or take into account personal strengths of students.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk—Read-Only Memory (CD-ROM), Compact Disk—Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A system for computerized knowledge acquisition, the system comprising:
a knowledge level testing module to present to a student a first set of questions in a modality at one or more difficulty levels, to receive from the student answers to said first set of questions, and to update a knowledge map of said student based on said answers;
a guided knowledge acquisition module to present to the student a second set of questions in said modality, wherein the second set of questions corresponds to educational items for which it is determined that the student's performance in the first set of questions is below a threshold value; and
a recycler module to present to the student an interactive game and a third set of questions in said modality, wherein the third set of questions corresponds to educational items for which it is determined that the student's performance in the first set of questions is equal to or greater than said pre-defined threshold.

2. The system of claim 1, wherein the modality comprises a version of a digital learning activity adapted to accommodate a difficulty level appropriate to said student, and further adapted to accommodate at least one of: a learning preference associated with said student, and a weakness of said student.

3. The system of claim 2, wherein the modality comprises a version of the digital learning activity adapted by at least one of:
addition of a feature of said digital learning activity;
removal of a feature of said digital learning activity;
modification of a feature of said digital learning activity;
modification of a time limit associated with said digital learning activity;
addition of audio narration;
addition of a calculator tool;
addition of a dictionary tool;
addition of a on-mouse-over hovering bubble;
addition of one or more hints;
addition of a word-bank; and
addition of subtitles.

4. The system of claim 2, wherein the knowledge level test module is to perform, for each modality from a list of modalities associated with a learning subject, a first sub-test for a first difficulty level of said modality; and if the student's performance in said sub-test is equal to or greater than said threshold level, the knowledge level test module is to perform a second sub-test for a second, different, difficulty level of said modality.

5. The system of claim 2, wherein the knowledge level test module is to modify status of at least one of the first set of questions into a value representing one of: pass, fail, skip, and untested.

6. The system of claim 2, wherein the knowledge level test module is to dynamically generate said first set of questions based on:
a discipline parameter,
a study unit parameter,
a threshold parameter indicating a threshold value for advancement to an advanced difficulty level; and
a batch size parameter indicating a maximum batch size for each level of difficulty.

7. The system of claim 6, wherein the knowledge level test module is to dynamically generate the first set of questions further based on a parameter indicating whether to check the threshold value per set of questions or per modality.

8. The system of claim 6, wherein the knowledge level test module is to dynamically generate the first set of questions further based on a level dependency parameter indicating whether or not to check the student's success in a previous difficulty level.

9. The system of claim 6, wherein the knowledge level test module is to dynamically generate the first set of questions further based on data from a student profile indicating, for at least one discipline, at least one of: a pedagogic strength of the student, and a pedagogic weakness of the student.

10. The system of claim 4, wherein the guided knowledge acquisition module is to check, for each difficulty level in a plurality of difficulty levels associated with said modality, whether or not the student's performance in said modality at said difficulty level is smaller than said threshold value; and if the check result is negative, to advance the student to a subsequent, increased, difficulty level for said modality.

11. The system of claim 4, wherein the guided knowledge acquisition module is to advance the student from a first modality to a second modality according to an ordered list of modalities for said student in a pedagogic discipline.

12. The system of claim 2, wherein the guided knowledge acquisition module is to present to the student a selectable option to receive a hint for at least one question of said second set of questions, based on a value of a parameter indicating whether or not to present hints to said student in said second set of questions.

13. The system of claim 2, wherein the guided knowledge acquisition module is to present to the student a question in said second set of question, the question including two or more numerical values generated pseudo-randomly based on number of digits criteria.

14. The system of claim 2, wherein the guided knowledge acquisition module is to present to the student two consecutive trials to correctly answer a question in said second set of questions, prior to presenting to the student a correct answer to said question.

15. The system of claim 2, wherein the interactive game presented by the recycler module comprises a game selected from the group consisting of: a memory game, a matching game, a spelling game, a puzzle game, and an assembly game.

16. The system of claim 2, wherein the interactive game presented by the recycler module comprises a combined list of vocabulary words, which is created by the recycler module based on: a first list of vocabulary words that the student mastered in a first time period ending at the creation of the combined list of vocabulary words, and a second list of vocabulary words that the student mastered in a second time period ending prior to the beginning of the first time period.

17. The system of claim 16, wherein the recycler module is to create said combined list of vocabulary words based on: the first list of vocabulary words sorted based on respective recycling counters, and the second list of vocabulary words sorted based on respective recycling counters.

18. The system of claim 16, wherein approximately half of vocabulary words in the combined list are included in the first list, and wherein approximately half of vocabulary words in the combined list are included in the second list.

19. A method of computerized knowledge acquisition, the method comprising:
presenting to a student a first set of questions in a modality at one or more difficulty levels;
receiving from the student answers to said first set of questions;
updating a knowledge map of said student based on said answers;
presenting to the student a second set of questions in said modality, wherein the second set of questions corresponds to educational items for which it is determined that the student's performance in the first set of questions is below a threshold value;
presenting to the student an interactive game and a third set of questions in said modality, wherein the third set of questions corresponds to educational items for which it is determined that the student's performance in the first set of questions is equal to or greater than said pre-defined threshold.

20. The method of claim 19, wherein the modality comprises a version of a digital learning activity adapted to accommodate a difficulty level appropriate to said student, and further adapted to accommodate at least one of: a learning preference associated with said student, and a weakness of said student.

21. The method of claim 20, wherein the modality comprises a version of the digital learning activity adapted by at least one of:
addition of a feature of said digital learning activity;
removal of a feature of said digital learning activity;
modification of a feature of said digital learning activity;
modification of a time limit associated with said digital learning activity;
addition of audio narration;
addition of a calculator tool;
addition of a dictionary tool;
addition of a on-mouse-over hovering bubble;
addition of one or more hints;
addition of a word-bank; and
addition of subtitles.

22. The method of claim 20, comprising:
performing, for each modality from a list of modalities associated with a learning subject, a first sub-test for a first difficulty level of said modality; and
if the student's performance in said sub-test is equal to or greater than said threshold level, performing a second sub-test for a second, different, difficulty level of said modality.

23. The method of claim 20, comprising:
modifying status of at least one of the first set of questions into a value representing one of:
pass, fail, skip, and untested.

24. The method of claim 20, comprising:
dynamically generating said first set of questions based on:
a discipline parameter,
a study unit parameter,
a threshold parameter indicating a threshold value for advancement to an advanced difficulty level; and
a batch size parameter indicating a maximum batch size for each level of difficulty.

25. The method of claim 24, comprising:
dynamically generating the first set of questions further based on a parameter indicating whether to check the threshold value per set of questions or per modality.

26. The method of claim 24, comprising:
dynamically generating the first set of questions further based on a level dependency parameter indicating whether or not to check the student's success in a previous difficulty level.

27. The method of claim 24, comprising:
dynamically generating the first set of questions further based on data from a student profile indicating, for at least one discipline, at least one of: a pedagogic strength of the student, and a pedagogic weakness of the student.

28. The method of claim 22, comprising:
for each difficulty level in a plurality of difficulty levels associated with said modality, checking whether or not the student's performance in said modality at said difficulty level is smaller than said threshold value; and
if the checking result is negative, advancing the student to a subsequent, increased, difficulty level for said modality.

29. The method of claim 22, comprising:
advancing the student from a first modality to a second modality according to an ordered list of modalities for said student in a pedagogic discipline.

30. The method of claim 20, comprising:
presenting to the student a selectable option to receive a hint for at least one question of said second set of questions, based on a value of a parameter indicating whether or not to present hints to said student in said second set of questions.

31. The method of claim 20, comprising:
presenting to the student a question in said second set of question, the question including two or more numerical values generated pseudo-randomly based on number of digits criteria.

32. The method of claim 20, comprising:
presenting to the student two consecutive trials to correctly answer a question in said second set of questions, prior to presenting to the student a correct answer to said question.

33. The method of claim 20, wherein the interactive game comprises a game selected from the group consisting of: a memory game, a matching game, a spelling game, a puzzle game, and an assembly game.

34. The method of claim 20, wherein the interactive game comprises a combined list of vocabulary words, which is created based on: a first list of vocabulary words that the student mastered in a first time period ending at the creation of the combined list of vocabulary words, and a second list of vocabulary words that the student mastered in a second time period ending prior to the beginning of the first time period.

35. The method of claim 34, comprising:
creating said combined list of vocabulary words based on: the first list of vocabulary words sorted based on respective recycling counters, and the second list of vocabulary words sorted based on respective recycling counters.

36. The method of claim 34, wherein approximately half of vocabulary words in the combined list are included in the first list, and wherein approximately half of vocabulary words in the combined list are included in the second list.
